(19) United States
(12) Patent Application Publication
(10) Pub. No.: US 2025/0327443 A1
(43) Pub. Date: Oct. 23, 2025

(54) THERMOELASTIC CONTROLLER WITH A COMPACT DESIGN

(71) Applicant: MATELIGENT GMBH, Saarbrucken (DE)

(72) Inventors: Yannik GOERGEN, Saarbrucken (DE); Dominik SCHOLTES, Saarbrucken (DE); Lukas ZIMMER, Saarbrucken (DE); Rouven BRITZ, Saarbrucken (DE); Jens PREETZ, Owingen (DE); Stefan SEELECKE, Saarbrucken (DE); Paul MOTZKI, Saarbrucken (DE)

(73) Assignee: MATELIGENT GMBH, Saarbrucken (DE)

(21) Appl. No.: 18/868,829

(22) PCT Filed: May 25, 2022
(86) PCT No.: PCT/EP2022/064242

§ 371 Date: Nov. 25, 2024

(51) Int. Cl. F03G 7/06

(52) U.S. Cl. CPC F03G 7/06114

(57) ABSTRACT

The invention relates to a thermoelastic actuator (1) for providing a rotary actuating motion, comprising:
an actuating element (4) for outputting the rotatory actuating motion;
an antagonistic actuator unit (2) coupled with the actuating element (4) to convert a translational movement into the rotary actuating motion;
   wherein the antagonistic actuator unit (2) comprises:
at least two electrically separately activatable thermoelastic actuator elements (21, 21a, 21b), each extending in an extension direction (R) from a first end to a second end and arranged parallel to each other;
a carriage element (24), which is movably guided in the direction (R), where the thermoelastic actuator elements (21, 21a, 21b) are each connected at the second end to the carriage element (24), so that upon a change of shape upon activation of one of the actuator elements (21, 21a, 21b), a pulling force is exerted on the carriage element (24) to translationally move the carriage element (24);
an electrical connection between the first ends of the actuator elements (21, 21a, 21b) connected to the carriage element (24), so that a common electrical potential is applied to the actuator elements (21, 21a, 21b) via the carriage element (24).

### TECHNICAL FIELD

The invention relates to thermoelastic actuators, particularly actuators with thermoelastic actuator elements in a compact design.

### TECHNICAL BACKGROUND

Actuators for converting an electrical control into a mechanical actuating motion are used in a variety of technical devices, such as motor vehicles, household appliances, and the like. Such electromechanical actuators enable controlled movement of elements within a device and/or the exertion of force on them.

Typically, actuators are equipped with electromotive actuators, usually designed as rotary electric motors. These must be position-controlled when adjusting a positioning element to specify a particular position of the actuator.

Another group of actuators are known as actuators with thermoelastic actuator elements as active elements. Thermoelastic actuator elements typically consist of a thermoelastic material (also referred to as elastocaloric or mechanocaloric material), e.g., a shape memory alloy, which undergoes a shape change upon temperature change, and vice versa. Thermoelastic materials change their microstructure when exposed to temperature, leading to a change in geometry or exertion of force. In particular, thermoelastic elements can reduce their dimensions when heated, e.g., exerting a pulling force. Thermoelastic elements designed as actuator elements can contract when exposed to heat and thereby causing an actuating motion. In the case of cooling, especially with an appropriate restoring force applied, the thermoelastic element reassumes its original shape.

However, actuators with thermoelastic actuator elements have the disadvantage that, due to the required length of the thermoelastic actuator elements, they are not compact and thus cannot be used in a variety of possible applications due to their size,

It is therefore an object of the present invention to provide an improved thermoelastic actuator that is compact, robust, and has a long service life or high cycle durability.

### SUMMARY OF THE INVENTION

This object is achieved by the thermoelastic actuator according to claim 1.

Further embodiments are indicated in the dependent claims.

According to a first aspect, a thermoelastic actuator for providing a rotary actuating motion is provided, comprising:
an actuating element for outputting the rotary actuating motion;
an antagonistic actuator unit coupled with the actuating element to convert a translational movement into the rotary actuating motion;
   wherein the antagonistic actuator unit comprises:
at least two electrically activatable thermoelastic actuator elements, each extending in an extension direction from a first end to a second end and arranged parallel to each other;
a carriage element, which is movably guided in the direction of extension, where the thermoelastic actuator elements are each connected at the second end to the carriage element, so that upon a change of shape upon activation of one of the actuator elements, a pulling force is exerted on the carriage element to translational move the carriage element;
an electrical connection between the first ends of the actuator elements connected to the carriage element, so that a common electrical potential is applied to the actuator elements via the carriage element.

The core of the above thermoelastic actuator is an antagonistic actuator unit in which two thermoelastic actuator elements act as antagonists on a carriage element. The carriage element is translationally movably guided in a direction of extension and is thus moved by contraction in a first direction by one of the actuator elements and by contraction in a second direction opposite the first by another of the actuator elements. By alternately electrically controlling the actuator elements, these can be alternately heated, while the other actuator element cools down or is cooled down by the cooler ambient temperature. Thus, the actuated actuator element of the antagonistic actuator unit can selectively move the carriage element in the first or the opposite second direction of extension, while the non-active actuator element is stretched.

Since the first end of the actuator elements is fixedly connected to the housing, a force acting upon activation of one of the actuator elements can be absorbed in the housing and transferred to the carriage element.

The actuator elements are controlled electrically, i.e., by supplying electrical energy to heat the respective actuator element. A corresponding electric current is passed through the entire extension of the respective actuator element. The heating causes a contraction, which moves the carriage element translationally.

In order for the actuator elements to be antagonistically controlled, they can be electrically connected to one another via a center connection. This means the actuator elements are electrically connected to each other at one of their ends.

The first and second actuator elements can be formed as wire bundle actuator elements. This has the advantage that due to the increased surface area, good heat dissipation to the environment is ensured, and moreover, a high actuating force can be exerted by such an actuator element.

Preferably, the carriage element can be substantially accommodated between the actuator elements. Thus, to realize the compact design, the actuator elements are substantially parallel to each other. Alternatively, the actuator elements and the carriage element can also be arranged next to each other.

According to one embodiment, the carriage element and/or the housing may have through-openings in the form of slots, holes or a lattice structure to allow heat dissipation of the actuator elements by convection or an introduced airstream.

According to one embodiment, an electrically conductive connecting conductor may be arranged on or at the carriage element to electrically connect the second ends of the thermoelastic actuator elements connected to the carriage element.

The carriage element is configured to be electrically conductive or has a connecting conductor provided on or in the carriage element. The electrically conductive connection electrically connects the points of connection of the two actuator elements on the carriage element so that the first and second actuator elements can be applied with a common potential via the carriage element as a center connection.

A contacting device with a spring contact or a sliding contact may be provided to electrically contact the movable connecting conductor. The spring contact and the sliding contact have the advantage that a wire connection can be avoided, which is susceptible to failure due to repeated motion stress.

Selective energization of one of the actuator elements can be ensured by a connection device to the carriage element, with which a first connection of the actuator elements can be connected to a predetermined first voltage potential. The respective other second electrical connection of the actuator elements can then be controlled by selectively connecting it to a corresponding further voltage potential to achieve a current flow and a resulting contraction.

The energization of the actuator elements is carried out alternately. Thus, only one of the two actuator elements is energized at a time, so that it contracts and moves the carriage element. The other of the actuator elements is stretched by the resulting movement of the carriage element. The transfer of the contraction of the energized actuator element to the non-activated actuator element is thus carried out via the movable carriage element.

The first and/or second ends of the actuator elements may have holding elements with through-openings to accommodate a respective fixing element. In particular, the fixing elements can be electrically conductive to energize the actuator elements via the accommodated holding elements.

A gear can transfer the translational movement of the carriage element to an actuating element, which is configured either for a translational or rotary movement.

Furthermore, the actuating element can be coupled with a braking device to hold the actuating element against a given constant or variable holding torque.

### BRIEF DESCRIPTION OF THE DRAWINGS

Embodiments are explained in more detail below with reference to the attached drawings, in which:

FIG. 1 shows a perspective view of the thermoelastic actuator with an open housing;

FIG. 2 shows a top view of the thermoelastic actuator of FIG. 1;

FIG. 3 shows a sectional view through the thermoelastic actuator of FIG. 1 along cutting line B-B;

FIG. 4 shows a perspective view of the thermoelastic actuator with a closed housing;

FIG. 5 shows a sectional view through the thermoelastic actuator of FIG. 1 along cutting line A-A;

FIG. 6 shows an exploded view through the thermoelastic actuator of FIG. 1; and

FIG. 7 shows a view of the underside of the circuit board of the thermoelastic actuator of FIG. 1.

### DESCRIPTION OF EMBODIMENTS

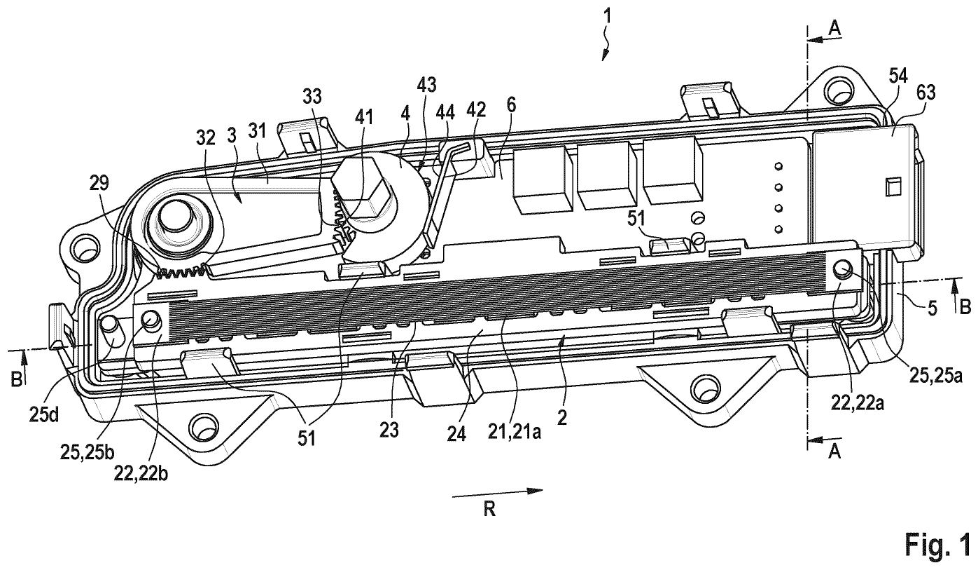

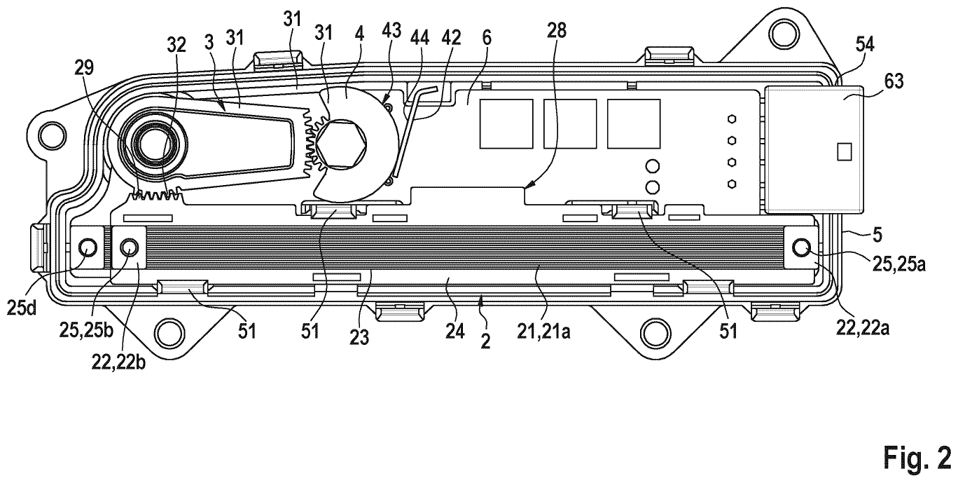

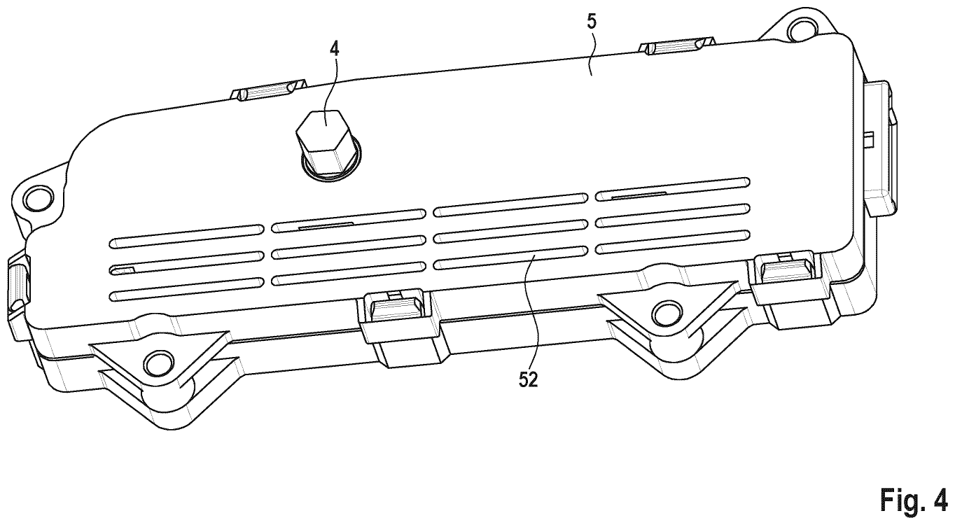

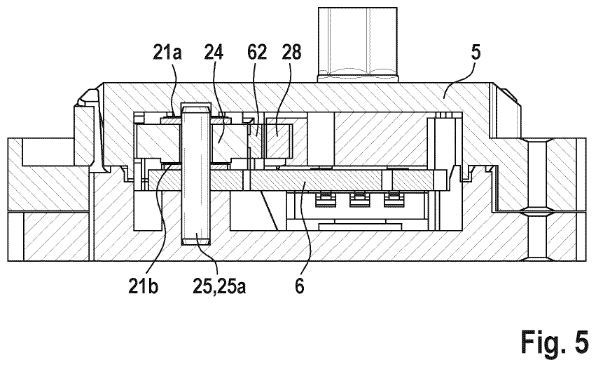

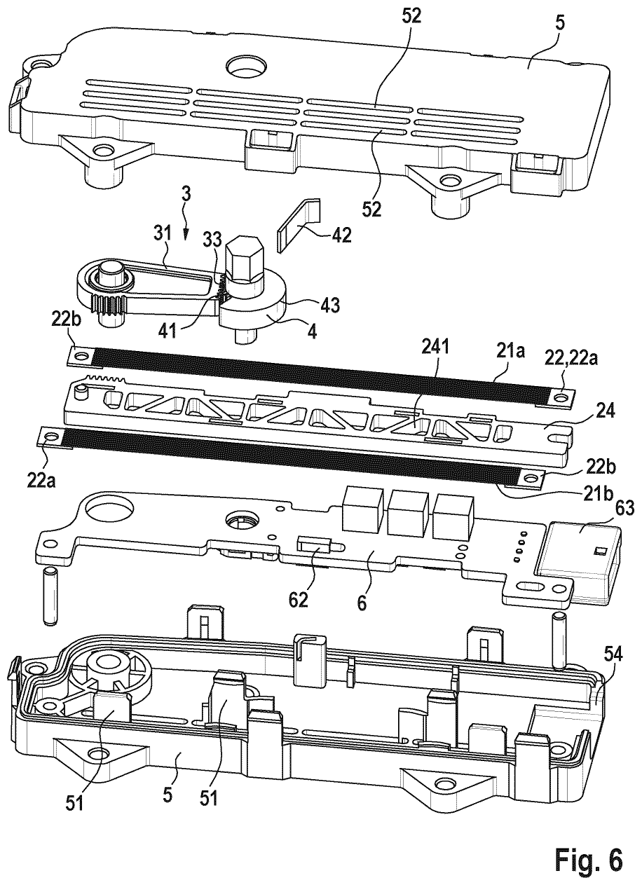

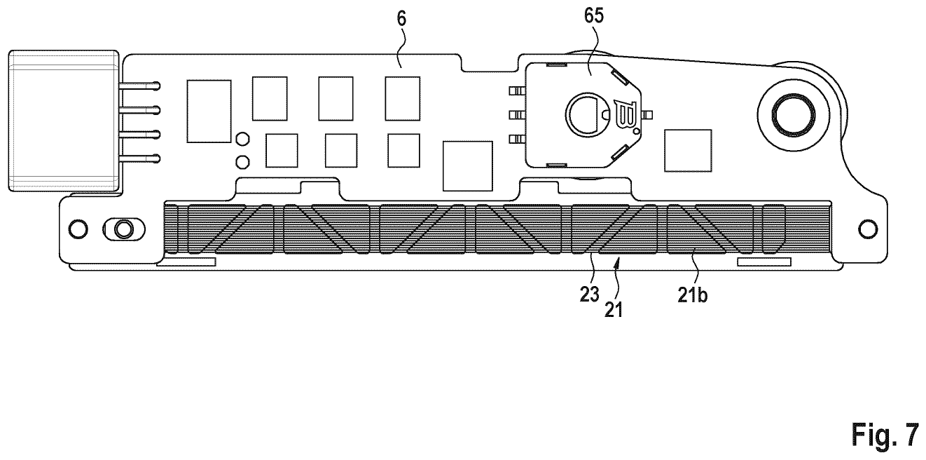

FIGS. 1 to 7 show various views of an exemplary thermoelastic actuator 1 with an antagonistic actuator unit 2, a gear 3, and a movable actuating element 4, from which a mechanical motion or a force or a torque can be decoupled from the actuator 1. The thermoelastic actuator 1 is enclosed in a housing 5, in which the antagonistic actuator unit 2, the gear 3, the actuating element 4, and a circuit board 6 for ensuring electronic control and electrical contacting of the actuator unit 2 are provided.

The antagonistic actuator unit 2 has two actuator elements 21, which are designed as thermoelastic actuator elements 21. The thermoelastic actuator elements 21 correspond to conductive actuator elements 21 made of a conductive thermoelastic material, which is preferably formed with or from a shape memory alloy.

The actuator elements 21 can be designed as wire bundle actuator elements, each having a plurality of actuator wires 23 running parallel to each other between two holding elements 22. The holding elements 22 at the ends of the actuator elements 21 serve to enable force decoupling from the longitudinally extending actuator elements 21. The holding elements 22 fix the actuator wires 23 so that they do not detach even when force is applied.

As can be seen from the figures, the actuator unit 21 is formed with a first actuator element 21a and a second actuator element 21b, which extend substantially parallel to each other in an extension direction R and between which a carriage element 24 is sandwiched. The carriage element 24 can be held in the housing 5 by suitable guiding means 51, so that the carriage element 24 can preferably move only in a translational movement substantially in the extension direction R of the extension of the actuator elements 21a, 21b.

The actuator elements 21a, 21b have a length that allows a significant change in length in order to couple out a force for adjusting the actuator 1. For example, the actuator elements 21a, 21b may have a length between 5 cm and 25 cm.

The carriage element 24 can have through openings 241, in particular in the form of slots, holes or a lattice structure, in order to allow heat from the actuator elements 21a, 21b to be dissipated by convection.

Furthermore, a first of the holding elements 22a of the first actuator element 21, 21a is fixedly located by means of a fixing element 25, which in the illustrated embodiment can be designed as a first fixing pin 25a insertable into the housing 5, in the housing 5, so that a force acting in the extension direction R can be absorbed by the housing 5. Analogously, a first of the holding elements 22a of the second actuator element 21, 21b is fixedly located by means of a fixing element 25, which in the illustrated embodiment can be designed as a fourth fixing pin 25d insertable into the housing 5, in the housing 5, so that a force acting in the extension direction R can be absorbed by the housing 5. Instead of the first and fourth fixing pins 25a, 25d, fixing screws or similar fixing devices can also be used.

A second of the holding elements 22b of the first actuator element 21a, which is opposite the first holding element 21a, is connected with the particularly elongated carriage element 24 movably guided in the extension direction R, so that the first actuator element 21a extends at least partially parallel to the carriage element 24. A second of the holding elements 22b of the second actuator element 21b, which is opposite the first holding element 21b, is connected with the particularly elongated carriage element 24 movably guided in the extension direction R, so that the second actuator element 21b extends at least partially parallel to the carriage element 24. Preferably, for reasons of compactness, the carriage element 24 can be completely covered in the extension direction R by the respective actuator element 21, 21a, 21b. For this purpose, the second holding element 22b of each of the actuator elements 21a, 21b can be coupled to the carriage element 24 via a corresponding fixing element 25 at an end of the respective actuator element 21a, 21b opposite the first holding element 22a. The corresponding exemplary second and third fixing pins 25b, 25c and the second holding elements 22b attached thereto are each connected to the carriage element 24 and are not fixedly located with respect to the housing 5. The second and third fixing pins 25b, 25c and the second holding elements 22b attached to them move together with the carriage element 24 and relative to the housing 5.

The holding elements 22, 22a, 22b preferably have a receiving opening through which the fixing pins 25a, 25b, 25c, 25d protrude in the assembled state, thus fixing the holding elements 22, 22a, 22b. Such a connection has the advantage that it is detachable, thus the actuator elements 21a, 21b can be easily replaced when needed by pulling them off the fixing pins 25 and placing them back on. Optionally, the actuator elements 21 may be secured against detaching from the fixing elements 25 by snap rings or other security devices.

In particular, the first holding element 22a of the first actuator element 21a is connected to the housing 5 via a first fixing pin 25a, the second holding element 22a of the first actuator element 21a via a second fixing pin 25b with the carriage element 24, the first holding element 22a of the second actuator element 21b via a third fixing pin 25c with the carriage element 24, and the second holding element 22b of the second actuator element 21b via a fourth fixing pin 25d with the housing 5. The second and third fixing pins 25b, 25c are accommodated in the carriage element 24, preferably inserted.

The activation of the actuator elements 21, 21b is achieved by energizing, i.e., via the electrically conductive fixing elements 25a-25d, which are connected to the actuator elements 21a, 21b via the corresponding holding elements 22, 22a, 22b. To activate the actuator elements 21, 21b, a voltage is applied to them, leading to a current flow and an electrical power conversion in the respective actuator element 21, 21b. The power is dimensioned such that the respective actuator element 21a, 21b is heated, causing a contraction of the respective actuator element 21, 21b due to the thermoelastic material.

On the circuit board 6, electronic circuits can be provided to implement functions for control and communication with extremal devices. A communication interface for communication via a bus system, such as Ethernet, CAN, LIN, and the like, may be implemented so that control commands received can be executed depending on the respective actuator element 4. Furthermore, position data indicating a position of the actuating element or other movable components can be communicated externally to the actuator 1 via the communication interface. The functions may also include diagnostic and/or monitoring functions.

The actuator elements 21a, 21b can be alternately controlled via corresponding circuitry or electronics on the circuit board 6. For this purpose, the first holding element 22a of the first actuator element 21a is electrically contacted via the first fixing pin 25a and the first holding element 22a of the second actuator element via the fourth fixing pin 25d and electrically fixedly connected to the circuit board 6. The first and fourth fixing pins 25a, 25d are received in corresponding through-openings 61 of the circuit board 6 and are electrically contactable with an electrical voltage potential.

The fixing of the fixing elements 25 in the housing 5 or the circuit board 6 and in the carriage element 24 ensures that the actuator elements 21, the fixing elements 25, and the holding elements 22 are not subjected to transverse forces or relative movements apart from forces acting in the extension direction, thereby reducing material fatigue in these components. In particular, the electrical contacting of the first and fourth fixing pins 25a, 25d is not subject to any stress from movement.

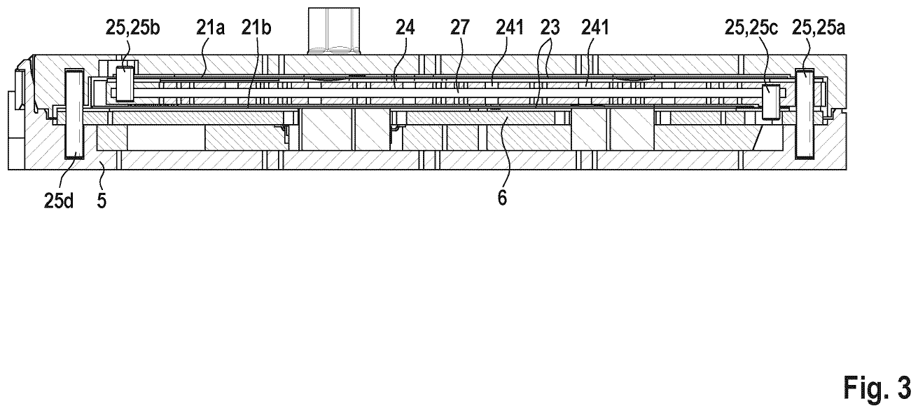

The first and second actuator elements 21a, 21b are electrically connected to each other. For this purpose, the second holding element 22b of the first actuator element 21a is electrically connected to the second holding element 22b of the second actuator element 21b through the carriage element 24. For this purpose, the carriage element 24 may be completely electrically conductive or provided with a connecting conductor 27 electrically applied thereon or embedded therein. The connecting conductor 27 ensures the electrical connection between the second fixing pin 25b and the third fixing pin 25c. For example, as shown in the cross-sectional view of FIG. 3, the carriage element 24 may be a molded part with an electrically conductive connecting conductor 27 embedded by overmolding, so that it is embedded as a core in the carriage element 24.

The electrical connecting conductor 27 in the carriage element 24 may be connected to an electrical voltage potential via the circuit board 6, allowing alternating control of the actuator elements 21a, 21b by selectively energizing the first or second actuator element 21a, 21b. A contacting element 62 for electrically contacting the connecting conductor 27 may be designed as a spring contact between the circuit board 6 and the carriage element 24, pressed against an electrical contact surface 28 of the carriage element 24. The electrical contact surface 28 is electrically connected to the connecting conductor 27 inside the carriage element 24. The contacting element 62 is attached to the circuit board 6 and is provided with a fixed voltage potential there.

Alternatively, the contacting element 62 can be designed as a sliding contact with a sliding bridge that is curved in the direction of the carriage element 24, in particular as a resilient, electrically conductive bracket. The force with which the contacting element 62 contacts the contact surface 28 is chosen so that a displacement of the carriage element 24 is not blocked, but nevertheless a sufficiently reliable electrical contacting is made possible.

The design of the contacting element 62 as a spring contact allows to avoid the use of contacting the carriage element 24 by means of a wire. Wire contacting has the disadvantage that due to the cyclic movement of the carriage element 24, continuous mechanical movement stress acts on such a wire contact, which can lead to a breakage of the connection wire and thus to a lower cycle durability of the actuator.

The carriage element 24 is provided with a rack section 29, which is coupled to the actuating element 4 via the gear 3. The gear 3 enables the conversion of the translational movement of the carriage element 24 into a rotary movement of the actuating element 4. The gear 3 has a first gear element 31 as a pivot lever, which has a toothed section 32 for engaging the rack section 29 and a toothed section 33 provided at a protruding end of the pivot lever, which engages with a pinion 41 of the actuating element 4. When the carriage element 24 moves, the first gear element 31 pivots, and the actuating element 4 rotates.

The actuating element 4 can be provided with a braking device 42, designed to hold the actuating element 4 in its last approached position with a specified holding torque in the absence of active control of the actuator elements 21. The braking device 42 can be realized for this purpose, for example, with a brake element 44 lying with force on a circular segment-shaped outer surface 43 to hold the actuating element 4 by frictional resistance against an externally acting moment with a holding torque. The braking device 42 can be designed to provide the same or different holding torques for different rotational directions. For this purpose, the outer surface 43 can be provided with micro-toothing that engages with a corresponding micro-toothing on the brake element 44.

The holding torque is effected by a latching of the micro-toothing, whose engagement is overcome when a maximum holding torque is exceeded. By asymmetrical tooth angles on the outer surface 43, different holding torques can be realized in different rotational directions of the actuating element 4.

Alternatively or additionally, a corresponding braking device may also be arranged on the carriage element 24 and/or the first gear element 31.

The circuit board 6 may be arranged in the housing 5 laterally offset from the thermoelastic actuator unit 2. The circuit board 6 can be designed to accommodate electrical components in a desired circuit layout. The circuit board 6 is contactable via a connection plug 63, so that the electrical power for energizing the actuator elements 21 can also be supplied via the connection plug 63. The connection plug 63 is accessible through an opening 54 in the housing 5.

Furthermore, the housing 5 may be provided with ventilation slots 52 to ensure heat dissipation from at least one of the actuator elements 21. The ventilation slots 52 are located directly opposite the respective actuator element 21 to ensure air circulation, so that the heat generated by activating the actuator elements 21 can be quickly dissipated into the environment of the actuator 1.

The actuating element 4 is rotatably arranged in the housing 5 and protrudes in the axial direction through the circuit board 6. For position determination (angular position) of the actuating element 4, it may be coupled with a potentiometer 65 or another kind of position sensor to detect the current rotary position of the actuating element 4. Alternatively, the position of the actuating element 4 can also be detected by the current lengths of the thermoelastic actuator elements 21a, 21b. For this purpose, a resistance measurement of the actuator elements 21a, 21b may be conducted. The dependence of the Ohmic resistance on the current length of the actuator elements 21a, 21b can be used to infer the position of the actuating element 4.

In another embodiment, the position of the actuating element 4 may be derived from a position of the carriage element 24. The position of the carriage element 24 may be suitably sensorially detected.

1. A thermoelastic actuator (1) for providing a rotary actuating motion, comprising:
an actuating element (4) for outputting the rotatory actuating motion;
an antagonistic actuator unit (2) coupled with the actuating element (4) to convert a translational movement into the rotary actuating motion;
wherein the antagonistic actuator unit (2) comprises:
at least two electrically separately activatable thermoelastic actuator elements (21, 21a, 21b), each extending in an extension direction (R) from a first end to a second end and arranged parallel to each other;
a carriage element (24), which is movably guided in the direction (R), where the thermoelastic actuator elements (21, 21a, 21b) are each connected at the second end to the carriage element (24), so that upon a change of shape upon activation of one of the actuator elements (21, 21a, 21b), a pulling force is exerted on the carriage element (24) to translationally move the carriage element (24);
an electrical connection between the first ends of the actuator elements (21, 21a, 21b) connected to the carriage element (24), so that a common electrical potential is applied to the actuator elements (21, 21a, 21b) via the carriage element (24).

2. The thermoelastic actuator (1) according to claim 1, wherein the carriage element (24) is completely or at least partially accommodated between the actuator elements (21, 21a, 21b).

3. The thermoelastic actuator (1) according to claim 1, wherein the carriage element (24) has through-openings, particularly in the form of slots, holes, or a lattice structure, to allow heat dissipation of the actuator elements (21, 21a, 21b) by convection.

4. The thermoelastic actuator (1) according to claim 1, wherein in or on the carriage element (24) an electrically conductive connecting conductor (27) is arranged as the electrical connection to electrically connect the second ends of the thermoelastic actuator elements (21, 21a, 21b connected to the carriage element (24).

5. The thermoelastic actuator (1) according to claim 4, wherein a contacting device (62) with a spring contact or a sliding contact is provided to electrically contact the connecting conductor (27), particularly over a circuit board (6) arranged laterally to the carriage element (24).

6. The thermoelastic actuator (1) according to claim 1, wherein the actuator elements (21, 21a, 21b) are designed as wire bundle actuator elements.

7. The thermoelastic actuator (1) according to claim 1, wherein the first end of the actuator elements (21, 21a, 21b) is fixedly connected to a housing of the actuator, so that a force acting upon activation of one of the actuator elements (21, 21a, 21b) can be absorbed in the housing and transferred to the carriage element (24).

8. The thermoelastic actuator (1) according to claim 1, wherein the first and/or second ends of the actuator elements (21, 21a, 21b) have holding elements with through-openings to accommodate a respective fixing element (25, 25a, 25b, 25c, 25d).

9. The thermoelastic actuator according to claim 8, wherein the fixing elements (25, 25a, 25b, 25c, 25d) are electrically conductive to energize the actuator elements (21, 21a, 21b) via the accommodated holding elements.

10. The thermoelastic actuator according to claim 1, wherein the actuating element (4) is coupled with a braking device (42) to hold the actuating element (4) with a holding torque against a torque acting from the outside, wherein particularly the holding torque for different rotational directions of the actuating element (4) is the same or different.

11. The thermoelastic actuator according to claim 1, with a housing (5), wherein at least one of the actuator elements (21, 21a, 21b) extends directly along a housing wall of the housing (5), wherein one or more ventilation slots (52) are provided in an area of the housing wall that faces the at least one actuator element (21, 21a, 21b).

12. The thermoelastic actuator according to one-of claim 1, wherein the carriage element (24) is provided with through-openings (241) to enhance heat dissipation from the actuator element (21a, 21b), particularly by convection.
